(19) United States
(12) Patent Application Publication
(10) Pub. No.: US 2022/0335442 A1
(43) Pub. Date: Oct. 20, 2022

(54) INFORMATION PROCESSING SYSTEM, INFORMATION PROCESSING DEVICE, AND INFORMATION PROCESSING METHOD

(71) Applicant: NAGASE & CO., LTD., Osaka (JP)

(72) Inventors: Shuzo IMAGAWA, Tokyo (JP); Kenji OKINO, Tokyo (JP); Kitahiro KANEDA, Tokyo (JP); Kimiko ARIKAWA, Tokyo (JP); Tatsuya UEKI, Tokyo (JP); Ayumi HIRABAYASHI, Tokyo (JP)

(21) Appl. No.: 17/762,977

(22) PCT Filed: Aug. 18, 2020
(86) PCT No.: PCT/JP2020/031057

§ 371 Date: Mar. 23, 2022

(30) Foreign Application Priority Data
Dec. 17, 2019 (JP) PCT/JP2019/049272

(51) Int. Cl. G06Q 30/00; H04L 9/00

(52) U.S. Cl. CPC G06Q 30/018; H04L 9/50; G06Q 2220/00

(57) ABSTRACT

The present invention conducts communication between transaction subjects for a change concerning manufacture or evaluation of an article more reliably while reducing a burden on a person in charge. An information processing system (1) includes: information processing devices (10) respectively associated with transaction subjects relating to article transactions; and a database (200) in which information of transaction content related to each transaction subject is registered by an information processing device (10) associated with that transaction subject. An information processing device (10_1) associated with the manufacturer includes: a change obtaining section (131) that obtains information of a change concerning manufacture or evaluation of the article; a user extracting section (132) that extracts, with reference to the database (200), a user to which the article has been sold; and a change transmitting section (133) that transmits the information of change to an information processing device (10_4) associated with the extracted user.

### TECHNICAL FIELD

The present invention relates to a technique for carrying out information processing in relation to transactions of articles.

### BACKGROUND ART

Techniques for carrying out information processing in relation to transactions of articles are known. Patent Literature 1 discloses a technique for tracing a pharmaceutical product by registering information, which indicates the pharmaceutical product that is an item of contents in a box to be delivered, in a blockchain and by registering the contents in the box when the box moves between target locations through a supply chain.

### CITATION LIST

### Patent Literature

[Patent Literature 1]

Published Japanese Translation of PCT International Application Tokuhyo No. 2019-502215 (Publication Date: Jan. 24, 2019)

### SUMMARY OF INVENTION

### Technical Problem

A manufacturer that manufactures an article has to inform users, which have purchased the article, of any change occurred in relation to manufacture or evaluation of the article. This is because, due to such a change, there is a possibility that a user that carries out a business using the article needs to apply for a change in the business that has been certified by a certification organization, or needs to modify a quality contract that has been concluded with the manufacturer. However, it is burdensome for a person in charge to contact, without omission, all users that have purchased the article. Patent Literature 1 does not indicate that such communication between transaction subjects is carried out more reliably while reducing the burden on the person in charge.

An object of an aspect of the present invention is to provide a technique for carrying out communication between transaction subjects for a change, which has occurred in relation to manufacture or evaluation of an article, more reliably while reducing a burden on a person in charge.

### Solution to Problem

In order to attain the object, an information processing system in accordance with an aspect of the present invention includes: information processing devices that are respectively associated with a plurality of transaction subjects relating to transactions of an article; and a database in which information indicative of transaction content related to each of the plurality of transaction subjects is registered by an information processing device associated with that transaction subject, the plurality of transaction subjects including a manufacturer that manufactures the article and a user that uses the article, among the information processing devices, an information processing device associated with the manufacturer including a change obtaining section that obtains information indicative of a change which has occurred in relation to manufacture or evaluation of the article, a user extracting section that extracts, with reference to the database, a user to which the manufacturer has sold the article, from among the plurality of transaction subjects, and a change transmitting section that transmits the information indicative of the change to an information processing device associated with the user which has been extracted by the user extracting section.

In order to attain the object, an information processing system in accordance with another aspect of the present invention includes information processing devices that are respectively associated with a plurality of transaction subjects relating to transactions of an ingredient of an article, each of the information processing devices including a transaction registering section that registers, in a database, transaction data indicative of transaction content of the ingredient of the article, the database being constituted by a blockchain that is shared by a plurality of nodes and has a sequence of blocks containing transaction data, and the plurality of nodes being configured to approve a block by using a predetermined consensus algorithm and the block being added to the blockchain.

In order to attain the object, an information processing device in accordance with an aspect of the present invention is an information processing device associated with a manufacturer that manufactures an article among a plurality of transaction subjects relating to transactions of the article, the information processing device including: a change obtaining section that obtains information indicative of a change which has occurred in relation to manufacture or evaluation of the article with use of a database in which information indicative of transaction content related to each of the plurality of transaction subjects is registered by an information processing device associated with that transaction subject; a user extracting section that extracts, with reference to the database, a user to which the manufacturer has sold the article, from among the plurality of transaction subjects; and a change transmitting section that transmits the information indicative of the change to an information processing device associated with the user which has been extracted by the user extracting section.

In order to attain the object, an information processing method in accordance with an aspect of the present invention is an information processing method carried out by an information processing device associated with a manufacturer that manufactures an article among a plurality of transaction subjects relating to transactions of the article, the method including the steps of: obtaining information indicative of a change which has occurred in relation to manufacture or evaluation of the article with use of a database in which information indicative of transaction content related to each of the plurality of transaction subjects is registered by an information processing device associated with that transaction subject; extracting, with reference to the database, a user to which the manufacturer has sold the article, from among the plurality of transaction subjects; and transmitting the information indicative of the change to an information processing device associated with the user which has been extracted by the user extracting section.

### Advantageous Effects of Invention

According to an aspect of the present invention, it is possible to carry out communication between transaction subjects for a change, which has occurred in relation to manufacture or evaluation of an article, more reliably while reducing a burden on a person in charge.

### BRIEF DESCRIPTION OF DRAWINGS

FIG. 1 is a block diagram illustrating a configuration of an information processing system in accordance with an embodiment of the present invention.

FIG. 2 is a block diagram illustrating a functional configuration of a node in accordance with an embodiment of the present invention.

FIG. 3 is a diagram schematically illustrating a configuration of a blockchain in accordance with an embodiment of the present invention.

FIG. 4 is a block diagram illustrating a functional configuration of an information processing device associated with a manufacturer in accordance with an embodiment of the present invention.

FIG. 5 is a block diagram illustrating a functional configuration of an information processing device associated with a user in accordance with an embodiment of the present invention.

FIG. 6 is a block diagram illustrating a functional configuration of an information processing device associated with a middleman in accordance with an embodiment of the present invention.

FIG. 7 is a flowchart showing an operation in which an information processing device in accordance with an embodiment of the present invention registers transaction content.

FIG. 8 is a flowchart showing an operation in which an information processing device in accordance with an embodiment of the present invention outputs information indicative of a transaction progress.

FIG. 9 is a flowchart showing an operation in which an information processing device in accordance with an embodiment of the present invention registers information indicative of reliability.

FIG. 10 is a flowchart showing an operation in which an information processing device in accordance with an embodiment of the present invention outputs information indicative of reliability.

FIG. 11 is a flowchart showing an operation in which information processing devices in accordance with an embodiment of the present invention communicate with each other.

FIG. 12 is a block diagram illustrating physical configurations of devices constituting an information processing system in accordance with an embodiment of the present invention.

### DESCRIPTION OF EMBODIMENTS

[Embodiment]

The following description will discuss details of an information processing system 1 in accordance with an embodiment of the present invention with reference to the drawings.

<Outline of Information Processing System 1>

The information processing system 1 is a system in which information processing devices that are respectively associated with a plurality of transaction subjects relating to transactions of an ingredient of a pharmaceutical product (hereinafter referred to as “pharmaceutical ingredient”) register transaction data indicative of transaction content of the pharmaceutical ingredient in a database constituted by a blockchain.

The information processing system 1 is a system for transmitting information, which indicates a change that has occurred in relation to manufacture of a pharmaceutical ingredient, to an information processing device associated with a user to which the pharmaceutical ingredient has been sold.

(Pharmaceutical Ingredient)

The pharmaceutical ingredient in accordance with the present embodiment is an example of an “article” in the present invention and includes an active pharmaceutical ingredient, an additive, and an ingredient/raw material of an active pharmaceutical ingredient.

(Plurality of Transaction Subjects)

The plurality of transaction subjects in accordance with the present embodiment include a manufacturer, a user, and a middleman. The manufacturer is a manufacturer that manufactures a pharmaceutical ingredient. The user is a user which uses the pharmaceutical ingredient. One exemplary user is a pharmaceutical company that manufactures a drug. The middleman is a trader included in a transaction route of the pharmaceutical ingredient.

Examples of the middleman include a broker such as a trading company, a warehouse that serves as a logistics base, and the like.

<Configuration of Information Processing System 1>

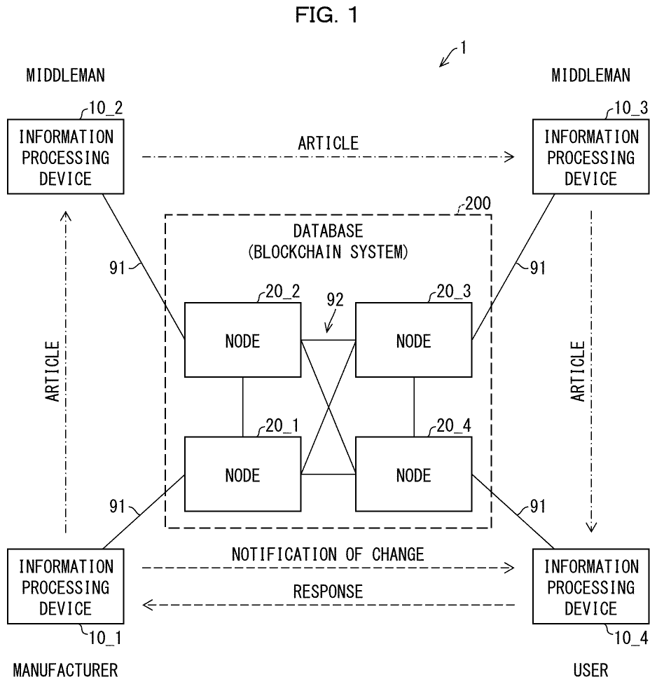

FIG. 1 is a block diagram illustrating a configuration of the information processing system 1 in accordance with an embodiment of the present invention. In FIG. 1, the information processing system 1 includes information processing devices 10_1 through 10_4 and a blockchain system 200.

The information processing devices 10_1 through 10_4 are devices that are respectively associated with a plurality of transaction subjects relating to transactions of the pharmaceutical ingredient. Specifically, the information processing device 10_1 is associated with the manufacturer. The information processing device 10_2 is associated with a middleman. The information processing device 10_3 is associated with another middleman. The information processing device 10_4 is associated with the user. The information processing devices 10_1 through 10_4 are examples of the information processing devices in accordance with the present invention. Hereinafter, the information processing devices 10_1 through 10_4 are each also referred to simply as “information processing device 10” when the information processing devices 10_1 through 10_4 do not need to be distinguished from each other. Each of the information processing devices 10 is connected, via a network, with at least one of nodes 20 so as to be capable of communicating with the nodes 20 which are included in the blockchain system 200.

FIG. 1 illustrates four information processing devices 10. However, the information processing system 1 only needs to include at least two information processing devices, i.e., the information processing device 10_1 associated with the manufacturer and the information processing device 10_4 associated with the user. The number of information processing devices included in the information processing system 1 is not limited to four. The information processing system 1 may also include information processing devices respectively associated with a plurality of manufacturers. The information processing system 1 may also include information processing devices respectively associated with a plurality of users. The information processing system 1 may also include an information processing device associated with one middleman or information processing devices respectively associated with three or more middlemen.

In addition, in FIG. 1, the dashed-dotted arrows indicate a flow of a physical distribution of an article (here, a pharmaceutical ingredient). In the example illustrated in FIG. 1, the pharmaceutical ingredient is delivered from the manufacturer via two middlemen to the user. Note that the number of middlemen included in the route until the pharmaceutical ingredient reaches the user is not limited to two, and may be one or three or more.

In FIG. 1, the dotted arrows indicate a flow of information. As illustrated in FIG. 1, in the information processing system 1, information indicative of a change which has occurred in relation to manufacture of the pharmaceutical ingredient is transmitted from the information processing device 10_1 associated with the manufacturer to the information processing device 10_4 associated with the user. In addition, information indicative of a response to the change is transmitted from the information processing device 10_4 associated with the user to the information processing device 10_1 associated with the manufacturer.

The blockchain system 200 includes nodes 20_1 through 20_4. The blockchain system 200 is an example of a database in accordance with the present invention.

Hereinafter, the nodes 20_1 through 20_4 are each also referred to simply as “node 20” when the nodes 20_1 through 20_4 do not need to be distinguished from each other. In FIG. 1, four nodes 20 are illustrated. However, the blockchain system 200 only needs to include a plurality of nodes 20, and the number of nodes 20 is not limited to four.

<Functional Configuration of Blockchain System 200>

The blockchain system 200 is a system for recording information by using a blockchain. As illustrated in FIG. 1, the blockchain system 200 includes the plurality of nodes 20. These nodes 20 are connected to each other via a peer to peer (P2P) network 92. The blockchain is a sequence of blocks in which information is recorded and which are shared by the plurality of nodes 20. Specifically, respective identical blockchains obtained by duplication of one blockchain are stored in the plurality of nodes 20, so that sharing of the blockchain by the plurality of nodes 20 is realized. Further, the plurality of nodes 20 approve a block according to a predetermined consensus algorithm, and this block is added to the blockchain.

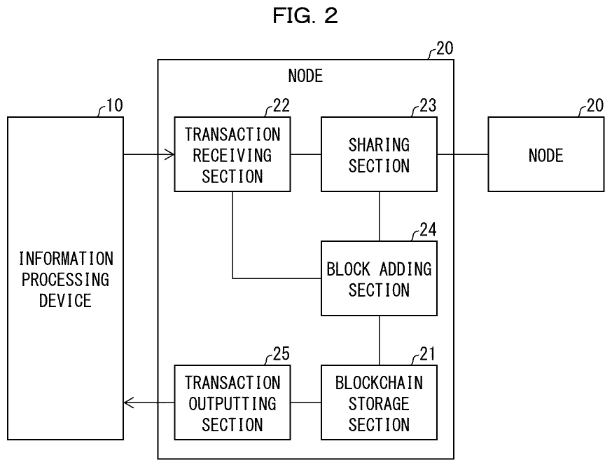

FIG. 2 is a block diagram illustrating a functional configuration of the node 20. In FIG. 2, the node 20 includes a blockchain storage section 21, a transaction receiving section 22, a sharing section 23, a block adding section 24, and a transaction outputting section 25.

The blockchain is stored in the blockchain storage section 21. The blockchain is synchronized so as to have the same content as respective blockchains stored in other blockchain storage sections 21 of other nodes 20.

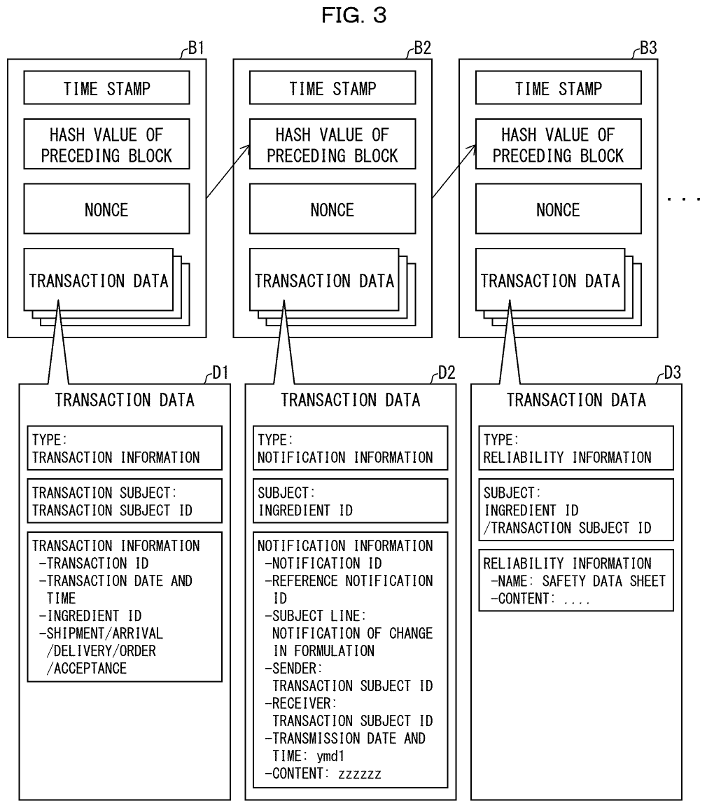

FIG. 3 is a diagram schematically illustrating configurations of a blockchain and of each of the blocks. In FIG. 3, each of blocks B1, B2, and B3 contains a time stamp, a hash value of an immediately preceding block, a nonce, and one or more pieces of transaction data. Since each of the blocks contains the hash value of the immediately preceding block, the order relationship between the blocks is defined and the blockchain is constructed. In FIG. 3, the blockchain including the blocks B1, B2, B3, . . . arranged in this order is formed. Note that the transaction data illustrated in FIG. 3 will be described later.

The transaction receiving section 22 obtains transaction data that is to be recorded in a blockchain. When the transaction receiving section 22 obtains the transaction data, the transaction receiving section 22 broadcasts the transaction data thus obtained to the other nodes 20 via the sharing section 23 (described later). Examples of the transaction data include, but are not limited to, information representing transaction details. In the present embodiment, the transaction data is received from the information processing device 10. Note however that the transaction data may be received from another device via a network, or may be inputted via an input device. Further, the transaction data may also be obtained by reading data that is stored in a portable storage medium.

The sharing section 23 transmits and receives data which is to be shared by the other nodes 20. For example, the sharing section 23 broadcasts the data obtained or generated by the node 20 to those other nodes 20. The sharing section 23 also receives data broadcasted from another node 20.

The block adding section 24 generates a block to be added to the blockchain. The block adding section 24 includes, in the block to be added, a hash value of the last block in the blockchain which is stored in the blockchain storage section 21. The block adding section 24 also includes, in the block to be added, one or more pieces of transaction data which has not yet been registered in the blockchain from among the transaction data obtained by the transaction receiving section 22 and transaction data received by the sharing section 23. Further, the block adding section 24 carries out a process for calculating, as a nonce to be included in the block to be added, a nonce which satisfies a predetermined condition. The process for calculating the nonce will be described later. In a case where the block to be added which is generated as described above is approved by the plurality of nodes 20 according to the predetermined consensus algorithm, the block adding section 24 adds the block thus generated to the blockchain stored in the blockchain storage section 21. Further, the block adding section 24 broadcasts, to the other nodes 20 via the sharing section 23, the block to be added.

In addition, the block adding section 24 adds, to the blockchain which is stored in the blockchain storage section 21, the block which has been received from that another node 20 via the sharing section 23. At this time, the block adding section 24 may first verify whether the block received from that another node 20 is a valid block which has been approved according to the predetermined consensus algorithm. Then, in a case where the block is verified to be valid, the block adding section 24 may carry out a process for adding the block.

The consensus algorithm is an algorithm for allowing the plurality of nodes 20 to agree on a single result. A typical known example of the consensus algorithm includes Proof of Work (PoW). In the PoW, a block generated by a node 20 which has first calculated a nonce that satisfies a predetermined condition among a plurality of nodes 20 is approved as a block to be added to a blockchain. Note that examples of the predetermined condition include, but are not limited to, a condition that a hash value of a block including the nonce has a predetermined number of zeros in succession at the beginning of the hash value. In the PoW, when the blockchain is forked in (a) a case where a plurality of nodes 20 have simultaneously calculated a nonce that satisfies the predetermined condition, (b) a case where there is an effect of a communication delay and/or the like, and/or (c) the like case, a longer blockchain is approved as valid. However, the consensus algorithm is not limited to the PoW, and another algorithm may be used.

On receipt of a search condition for retrieving transaction data, the transaction outputting section 25 retrieves, from the blockchain stored in the blockchain storage section 21, transaction data that satisfies the search condition, and then outputs the transaction data to the information processing device 10.

The blockchain system 200 configured as described above is characterized in that information recorded in the blockchain cannot be easily tampered or erased. Thus, the use of a blockchain for recording processes relating to transactions ensures the reliability of a resultant record. In addition, since the processes relating to all of the transactions are recorded without being tampered or erased after operations, traceability is achieved. The traceability of an article is accomplished by tracing, for an input (an article received) recorded in a certain piece of transaction data, another piece of transaction data in which an output (an article sent out) that is identical to the input is recorded.

Hereinafter, the blockchain shared by the nodes 20 of the blockchain system 200 is also referred to simply as “blockchain”.

<Functional Configuration of Information Processing Device 10>

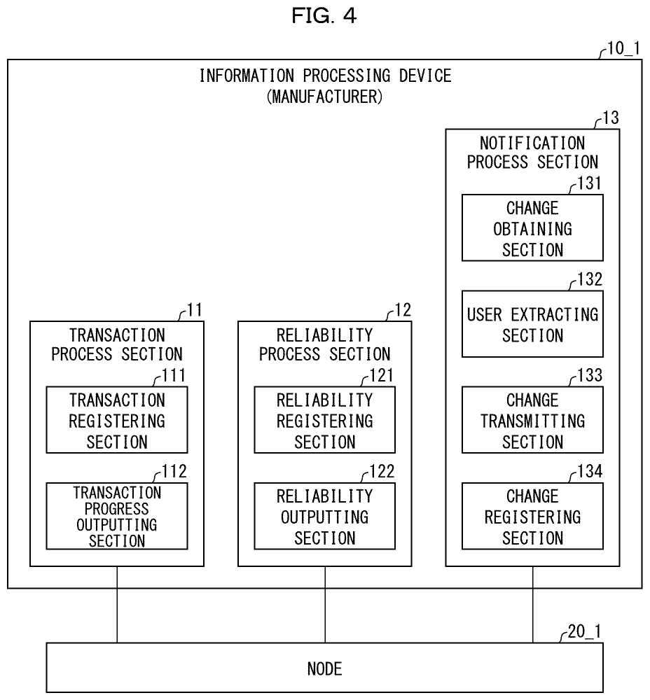

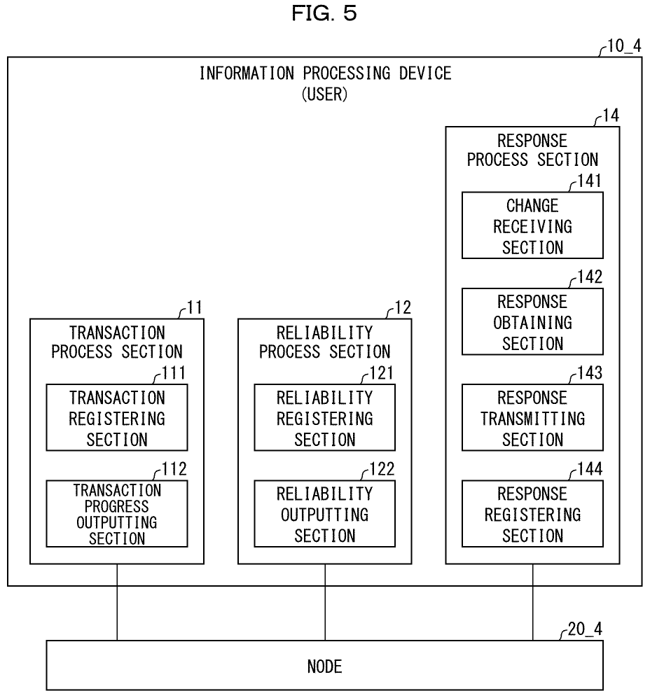

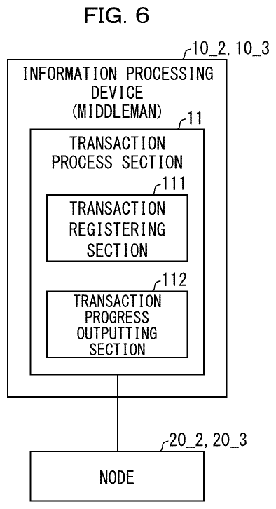

The following description will discuss a configuration of the information processing device 10 with reference to Figs. through 6. FIG. 4 is a block diagram illustrating a functional configuration of the information processing device 10_1. FIG. 5 is a block diagram illustrating a functional configuration of the information processing device 10_4. FIG. 6 is a block diagram illustrating a functional configuration of the information processing devices 10_2 and 10_3.

(Functional Configuration Common to Information Processing Devices 10_1 Through 10_4)

As illustrated in FIGS. 4 through 6, each of the information processing devices 10_1 through 10_4 includes a transaction process section 11. The transaction process section 11 is a component included commonly in the information processing devices 10_1 through 10_4. That is, the transaction process sections 11 are included in all the information processing devices 10 respectively associated with the transaction subjects, i.e., the manufacturer, the user, and the middleman. The transaction process section 11 includes a transaction registering section 111 and a transaction progress outputting section 112.

The transaction registering section 111 registers, when a transaction of the pharmaceutical ingredient has been carried out by a transaction subject associated with that information processing device, information indicative of transaction content of that transaction in the blockchain system 200. In the blockchain system 200, a block containing the information indicative of the transaction content as transaction data is added to the end of the blockchain by a node that has obtained a consensus among nodes. For example, the transaction registering section 111 may obtain, from an input device, information indicative of transaction content of the pharmaceutical ingredient carried out by the transaction subject, and may register transaction data, which has been generated with reference to the obtained information, in the blockchain system 200. Hereinafter, information indicative of transaction content is also referred to as transaction information.

Transaction data D1 illustrated in FIG. 3 is an example of transaction data registered by the transaction registering section 111, and contains a type, a transaction subject, and transaction information. The “type” indicates a type of transaction data. In this example, the type is “transaction information”. The “transaction subject” indicates a transaction subject ID for identifying a transaction subject which has carried out the transaction. The “transaction information” indicates content of the transaction, and contains, for example, a transaction ID, transaction date and time, an ingredient ID, and classifications such as shipment/arrival/delivery/order/acceptance. The “transaction ID” is an ID that is assigned so as to correspond to a transaction route of a pharmaceutical ingredient from when the pharmaceutical ingredient has been ordered from a manufacturer and to when the pharmaceutical ingredient has been delivered to a user, and is an ID which is used consistently in a series of transactions in the route. The “ingredient ID” indicates information for identifying a pharmaceutical ingredient for which the transaction has been carried out. Information contained in the transaction data indicative of transaction content is not limited to the pieces of information described above.

The transaction progress outputting section 112 outputs, with reference to the blockchain system 200, information indicative of the transaction progress of a pharmaceutical ingredient at a certain point in time. The transaction progress indicates a progress of a transaction on a transaction route. For example, the information indicative of a transaction progress may be information indicative of a transaction subject which has most recently carried out a transaction of the pharmaceutical ingredient. The information indicative of a transaction progress may be information indicative of a series of transaction subjects which have carried out transactions from when the pharmaceutical ingredient was ordered by the user to a certain point in time. For example, the transaction progress outputting section 112 may search the blockchain system 200 for transaction data containing a transaction ID of interest and containing transaction date and time before the certain point in time, from among pieces of transaction data of the type “transaction information”. In this case, the transaction progress outputting section 112 may output a most recent piece of transaction data among the retrieved pieces of transaction data as information indicative of the transaction progress, or may output information in which the retrieved pieces of transaction data are arranged in the order of transaction date and time. Note that the above described configuration of information indicative of a transaction progress and the process for generating the information indicative of the transaction progress are merely examples, and the present invention is not limited thereto.

(Functional Configuration Common to Information Processing Devices 10_1 and 10_4)

As illustrated in FIGS. 4 and 5, each of the information processing device 10_1 associated with the manufacturer and the information processing device 10_4 associated with the user includes a reliability process section 12 in addition to the transaction process section 11. That is, the reliability process sections 12 are included in the information processing devices 10 respectively associated with the manufacturer and the user. The reliability process section includes a reliability registering section 121 and a reliability outputting section 122.

The reliability registering section 121 registers, in the blockchain system 200, information indicative of reliability of a pharmaceutical ingredient or reliability of a transaction subject. Hereinafter, information indicative of reliability is also referred to as “reliability information”. Specific examples of the reliability information will be described later in detail.

Transaction data D3 illustrated in FIG. 3 is an example of transaction data registered by the reliability registering section 121, and contains a type, a subject, and reliability information. The “type” indicates a type of transaction data. In this example, the type is “reliability information”. The “subject” indicates an ID for identifying a pharmaceutical ingredient or a transaction subject to which the reliability information is related. The reliability information includes a name and content. In this example, the name is “safety data sheet”, but is not limited to this.

The reliability outputting section 122 outputs, with reference to the blockchain system 200, information indicative of reliability registered by another information processing device 10. The reliability outputting section 122 may further output information indicative of reliability registered by the information processing device 10 in which the reliability outputting section 122 itself is included. For example, the reliability outputting section 122 may search the blockchain system 200 for transaction data containing an ingredient ID or transaction subject ID of interest, from among pieces of transaction data of the type “reliability information”. In this case, the reliability outputting section 122 outputs a list of the retrieved pieces of transaction data.

(Functional Configuration of Information Processing Device 10_1)

As illustrated in FIG. 4, the information processing device 10_1 associated with the manufacturer includes a change process section 13, in addition to the transaction process section 11 and the reliability process section 12. The change process section 13 includes a change obtaining section 131, a user extracting section 132, a change transmitting section 133, and a change registering section 134.

The change obtaining section 131 obtains information indicative of a change that has occurred in relation to manufacture of a pharmaceutical ingredient. For example, the change obtaining section 131 obtains, as the information indicative of the change, information entered by a person in charge at the manufacturer with use of an input device. Specific examples of the change that has occurred in relation to manufacture of the pharmaceutical ingredient will be described later in detail.

The user extracting section 132 extracts, with reference to the blockchain system 200, a user to which the manufacturer has sold the pharmaceutical ingredient, from among the plurality of transaction subjects. For example, the user extracting section 132 may search for transaction data containing an ingredient ID of interest and containing information classified as “delivery”, from among pieces of transaction data of the type “transaction information”. In this case, the change obtaining section 131 extracts a user, which is indicated by the transaction subject ID contained in the retrieved transaction data, as the user to which the pharmaceutical ingredient has been sold. Note that the above described user extracting process is merely an example, and the user extracting section 132 may extract a user by another process.

The change transmitting section 133 transmits information indicative of a change to the information processing device 10_4 associated with the user which has been extracted by the user extracting section 132.

The change registering section 134 registers, in the blockchain system 200, information indicative of the change, which has been transmitted by the change transmitting section 133, while associating the information with the ingredient ID.

Transaction data D2 illustrated in FIG. 3 is an example of transaction data registered by the change registering section 134 or a response registering section 144 (described later), and contains a type, a subject, and notification information. The “type” indicates a type of transaction data.

In this example, the type is “notification information”. The “subject” indicates an ingredient ID for identifying a pharmaceutical ingredient related to the notification information. The “notification information” represents “information indicative of a change” and contains, for example, a notification ID, a reference notification ID, a subject line, a sender, a receiver, transmission date and time, and content. As the notification ID, an ID that identifies the notification information is assigned. The reference notification ID is set in a case where the reference notification ID is registered by the response registering section 144 (described later). The subject line includes, for example, information indicative of a subject line of the notification information. In this example, the subject line of the notification information is “Notification of change in formulation”, but is not limited to this.

(Functional Configuration of Information Processing Device 10_4)

As illustrated in FIG. 5, the information processing device 10_4 associated with the user includes a response process section 14, in addition to the transaction process section 11 and the reliability process section 12. The response process section 14 includes a change receiving section 141, a response obtaining section 142, a response transmitting section 143, and a response registering section 144.

The change receiving section 141 receives information indicative of the change, which has been transmitted from the information processing device 10_1.

The response obtaining section 142 obtains information indicative of a response to the change. For example, the response obtaining section 142 obtains, as the information indicative of the response, information entered by a person in charge at the user with use of an input device.

The response transmitting section 143 transmits the information indicative of the response to the information processing device 10_1, which has transmitted the information indicative of the change.

The response registering section 144 registers, in the blockchain system 200, information indicative of the response, which has been transmitted by the response transmitting section 143, while associating the information with the ingredient ID.

The following description will discuss transaction data registered by the response registering section 144, with reference to the transaction data D2 illustrated in FIG. 3. In this case, the transaction data D2 contains “information indicative of the response” as the notification information. In addition, in this case, the “information indicative of the response” contains, as a reference notification ID, a notification ID assigned to the information indicative of the change to which the response is made. The remaining items contained in the transaction data D2 are similar to those registered by the change registering section 134, and therefore descriptions thereof will not be repeated.

<Operations of Information Processing System 1>

The following will discuss operations of the information processing system 1 configured as described above, with reference to the drawings.

(Transaction Content Registration Operation)

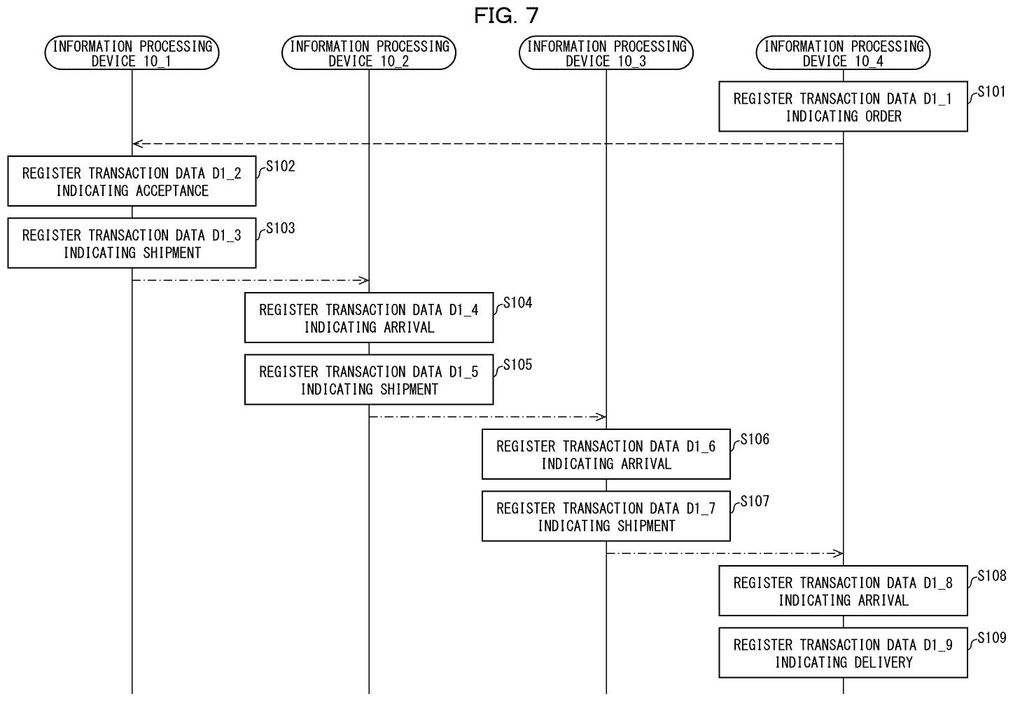

FIG. 7 is a sequence diagram illustrating an example of an operation in which the information processing device 10 registers transaction content. In FIG. 7, the dotted arrows indicate a flow of information. In addition, the dashed-dotted arrows indicate a flow of a physical distribution of a pharmaceutical ingredient. In the descriptions with reference to FIG. 7, pieces of transaction data D1_1 through D1_9 are examples of the transaction data D1 of the type “transaction information” in FIG. 3.

In a step S101, the transaction registering section 111 of the information processing device 10_4 associated with the user registers, when the pharmaceutical ingredient has been ordered, the transaction data D1_1 indicating the order content in the blockchain system 200. The order content indicated by the transaction data D1_1 is notified by the user to the manufacturer with a known method. The notification may be carried out via a middleman.

In a step S102, the transaction registering section 111 of the information processing device 10_1 associated with the manufacturer registers, when the order of the pharmaceutical ingredient indicated by the transaction data D1_1 has been accepted, the transaction data D1_2 indicating the acceptance content in the blockchain system 200.

In a step S103, the transaction registering section 111 of the information processing device 10_1 associated with the manufacturer registers, when the pharmaceutical ingredient indicated by the transaction data D1_2 has been shipped, the transaction data D1_3 indicating the shipment content in the blockchain system 200. The pharmaceutical ingredient indicated by the transaction data D1_3 is delivered to the middleman.

In a step S104, the transaction registering section 111 of the information processing device 10_2 associated with the middleman registers, when the pharmaceutical ingredient indicated by the transaction data D1_3 has arrived, the transaction data D1_4 indicating the arrival content in the blockchain system 200.

In a step S105, the transaction registering section 111 of the information processing device 10_2 associated with the middleman registers, when the pharmaceutical ingredient indicated by the transaction data D1_4 has been shipped, the transaction data D1_5 indicating the shipment content in the blockchain system 200. The pharmaceutical ingredient indicated by the transaction data D1_5 is delivered to another middleman.

In a step S106, the transaction registering section 111 of the information processing device 10_3 associated with that another middleman registers, when the pharmaceutical ingredient indicated by the transaction data D1_5 has arrived, the transaction data D1_6 indicating the arrival content in the blockchain system 200.

In a step S107, the transaction registering section 111 of the information processing device 10_3 associated with that another middleman registers, when the pharmaceutical ingredient indicated by the transaction data D1_6 has been shipped, the transaction data D1_7 indicating the shipment content in the blockchain system 200. The pharmaceutical ingredient indicated by the transaction data D1_7 is delivered to the user.

In a step S108, the transaction registering section 111 of the information processing device 10_4 associated with the user registers, when the pharmaceutical ingredient indicated by the transaction data D1_7 has arrived, the transaction data D1_8 indicating the arrival content in the blockchain system 200.

In a step S109, the transaction registering section 111 of the information processing device 10_3 associated with the user registers, when the delivery of the pharmaceutical ingredient indicated by the transaction data D1_8 has been completed, the transaction data D1_9 indicating the delivery content in the blockchain system 200.

As described above, the pieces of transaction data D1_1 through D1_9 indicating a series of transactions related to the pharmaceutical ingredient are registered in the blockchain system 200 in the order in which the transactions have been carried out.

Note that the above described registering operation is merely an example, and the order of carrying out the steps by the information processing devices, the content of the transaction data, the number of transaction subjects related to the transactions, and the like are not limited to this example.

(Operation for Outputting Information Indicative of Transaction Progress)

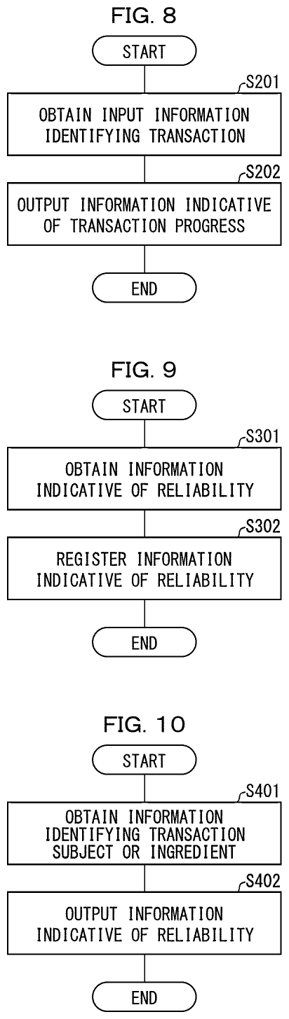

FIG. 8 is a flowchart showing an example of an operation in which each of the information processing devices 10 outputs information indicative of a transaction progress. This operation can be carried out in each of the information processing devices 10_1 through 10_4 in a similar manner.

In a step S201, the transaction progress outputting section 112 obtains information identifying a transaction through an input device. The information identifying a transaction is, for example, a transaction ID.

In a step S202, the transaction progress outputting section 112 outputs, with reference to the blockchain system 200, information indicative of a transaction progress at the time of carrying out this step to an output device such as a display. Specifically, the transaction progress outputting section 112 may search for transaction data containing the transaction ID obtained in the step S201 among pieces of transaction data of the type “transaction information”, and may output information in which the retrieved pieces of transaction data are arranged in the order of transaction date and time. The transaction progress outputting section 112 may output transaction data having the latest transaction date and time among pieces of transaction data retrieved in a similar manner.

For example, the following description assumes that the information processing device 10_4 associated with the user carries out an operation illustrated in FIG. 8 when the steps up to S104 illustrated in FIG. 7 have been carried out. In this case, the pieces of transaction data D1_1 through D1_4 are registered in the blockchain system 200 for the corresponding transactions. At this time, the transaction progress outputting section 112 outputs information in which the pieces of transaction data D1_1 through D1_4 are arranged in this order as information indicative of the transaction progress. Thus, the user can know that the ordered pharmaceutical ingredient has arrived at the middleman. As such, the user of each of the information processing devices 10 can ascertain the transaction progress of the pharmaceutical ingredient of interest and know the location of the pharmaceutical ingredient of interest.

(Operation for Registering Reliability Information)

FIG. 9 is a flowchart for describing an operation in which the information processing device 10_1 or 10_4 registers reliability information relating to a pharmaceutical ingredient or a transaction subject.

In a step S301, the reliability registering section 121 obtains reliability information indicative of reliability of the pharmaceutical ingredient or reliability of the transaction subject. For example, the reliability registering section 121 obtains, as the reliability information, information entered by a person in charge at the manufacturer or user with use of an input device.

In a step S302, the reliability registering section 121 registers, in the blockchain system 200, transaction data containing the obtained reliability information.

(Operation for Outputting Reliability Information)

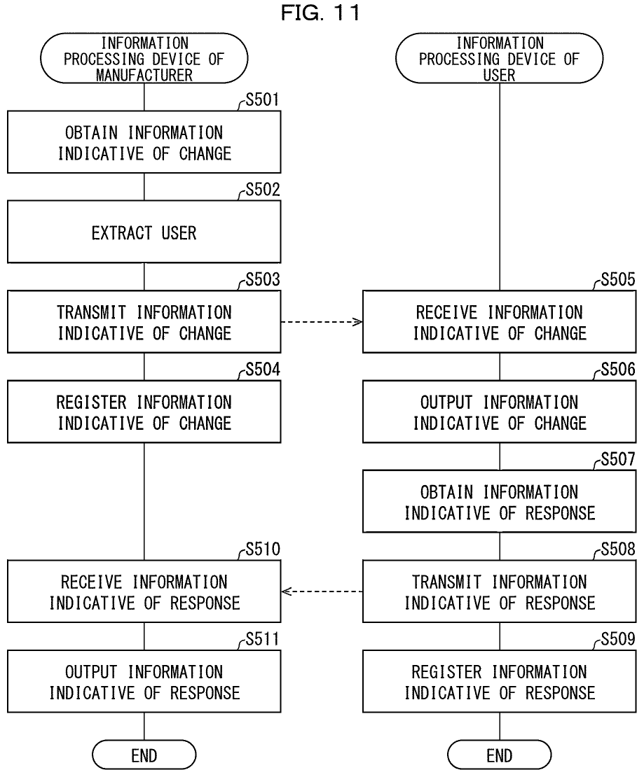

FIG. 10 is a flowchart for describing an operation in which the information processing device 10_1 or 10_4 outputs the reliability information.

In a step S401, the reliability outputting section 122 obtains information for identifying the pharmaceutical ingredient or the transaction subject. The obtained information contains, for example, an ingredient ID or a transaction subject ID.

In a step S402, the reliability outputting section 122 outputs reliability information registered by another information processing device 10 to an output device such as a display. For example, the reliability outputting section 122 searches for transaction data containing the ingredient ID or the transaction subject ID from among pieces of transaction data of the type “reliability information”, and outputs the reliability information contained in the retrieved transaction data. As a result, when the reliability information registered by that another information processing device 10 is registered in the blockchain system 200, the reliability information is outputted.

(Specific Example of Reliability Information)

Specific examples of the reliability information indicative of reliability of the user which is a transaction subject include pieces of information which respectively indicate a license for pharmaceutical handling business, a license for poisonous and deleterious substances handling business, and the like. These pieces of information are registered in the blockchain system 200 by the information processing device 10_4 associated with the user.

Examples of the reliability information indicative of reliability of the manufacturer, which is a transaction subject, include a license for manufacturing of drugs, a license for poisonous and deleterious substances handling business, an International Organization for Standardization (ISO) Certificate, a Good Manufacturing Practice (GMP) certificate, a third party auditing report, and the like. These pieces of information are registered in the blockchain system 200 by the information processing device 10_1 associated with the manufacturer.

Examples of the reliability information indicating reliability of the pharmaceutical ingredient include a safety data sheet, a Bovine Spongiform Encephalopathy (BSE)/Transmissible Spongiform Encephalopathy (TSE) certificate, an allergy certificate, an ingredient origin certificate, a Kosher/Halal certificate, a product catalog, a technical material, and the like. These pieces of information are registered in the blockchain system 200 by the information processing device 10_1 associated with the manufacturer.

If there is a change in the reliability information, an information processing device 10 associated with the manufacturer or user, which has registered the reliability information, registers transaction data containing new reliability information. Thus, for example, the user can obtain reliability information of the pharmaceutical ingredient used or reliability information of the manufacturer which manufactures the pharmaceutical ingredient from the information processing system 1 without inquiring of the manufacturer. As a result, an operation cost of the user is reduced. Moreover, for example, the manufacturer can obtain reliability information of the user, to which the pharmaceutical ingredient is sold, from the information processing system 1 without inquiring of the user. As a result, an operation cost of the manufacturer is reduced.

(Operation Carried Out Due to Change in Relation to Manufacture of Pharmaceutical Ingredient)

FIG. 11 is a flowchart for describing operations of the information processing system 1 carried out when a change has occurred in relation to manufacture of the pharmaceutical ingredient.

In a step S501, the change obtaining section 131 of the information processing device 10_1 associated with the manufacturer obtains information indicative of a change that has occurred in relation to manufacture of the pharmaceutical ingredient. For example, the information indicative of the change is entered by a person in charge at the manufacturer with use of an input device. The information indicative of the change contains an ingredient ID for identifying the pharmaceutical ingredient.

In a step S502, the user extracting section 132 extracts, with reference to the blockchain system 200, a user to which the pharmaceutical ingredient has been sold. Specifically, the user extracting section 132 searches for transaction data containing an ingredient ID of interest and containing a classification “delivery” from among pieces of transaction data of the type “transaction information”, and extracts a user indicated by a transaction subject ID contained in the retrieved transaction data. If the processes such as search and extraction need to be carried out faster, a scope of searching for transaction data may be narrowed down to a certain period of time or the like.

In a step S503, the change transmitting section 133 transmits the information indicative of the change to the information processing device 10_4 associated with the user which has been extracted in the step S502.

In a step S504, the change registering section 134 registers, in the blockchain system 200, the information indicative of the change which has been transmitted in the step S503.

In a step S505, the change receiving section 141 in the information processing device 10_4 associated with the user receives the information indicative of the change, which has been transmitted in the step S503.

In a step S506, the change receiving section 141 outputs the received information indicative of the change to an output device such as a display.

In a step S507, the response obtaining section 142 obtains information indicative of a response. The information indicative of the response is entered by, for example, a person in charge at the user with use of an input device, as a response to the change indicated by the information which has been outputted in the step S505. For example, the information indicative of the response includes agreement with the change, a request for suspending the change, or the like.

In a step S508, the response transmitting section 143 transmits the information indicative of the response, which has been obtained in the step S507, to the information processing device 10_1, which has transmitted the information indicative of the change.

In a step S509, the response registering section 144 registers, in the blockchain system 200, the information indicative of the response which has been transmitted in the step S507.

In a step S510, the change process section 13 of the information processing device 10_1 associated with the manufacturer receives the information indicative of the response.

In a step S511, the change process section 13 outputs the received information indicative of the response to an output device such as a display.

Then, the information processing system 1 ends the operations carried out in the case where the change has occurred in relation to the manufacture of the pharmaceutical ingredient.

<Application Example of Information Processing System 1>

The following description will discuss an application example in which the information processing system 1 is used to transmit information when a change has occurred in relation to manufacture of a pharmaceutical ingredient.

(Specific Examples of Change in Relation to Manufacture of Pharmaceutical Ingredient)

Specific examples of changes that are assumed to occur in relation to manufacture of the pharmaceutical ingredient will be described first. Such changes include, for example, the following.
Change of manufacturing method
Change of manufacturing scale
Change of analysis method
Change of standard
Change of manufacturing location
Change of manufacturing equipment
Change of test location
Addition/change of main raw material
Change of expiration date
Change of lot numbering manner
Change of packaging form
Change of labeling
Change of product name
Change of company name
Change of registered company address/telephone number, etc.
Change of transportation method
Change of stock location
Change of contact person in charge of quality
Deviation in manufacture/quality

Such changes in relation to manufacture of the pharmaceutical ingredient may affect one or both of (1) quality of a product and (2) content of license approved by a public institution. The “content of license approved by a public institution” is content of license for business using the pharmaceutical ingredient, and an example thereof includes, but is not limited to, a “certificate of approval for manufacture and sale”. The user, when informed of any change that has occurred in relation to manufacture of the pharmaceutical ingredient, determines a risk that may affect (1) quality of a product and (2) content of license approved by a public institution. Application Examples 1 through 3 of the information processing system 1 according to the determination results will be described below. Here, the public institution is an example of the “certification organization” in the present invention. The content of license approved is an example of “certification content which has been certified” in the present invention.

### APPLICATION EXAMPLE 1

In Application Example 1, a case will be described in which a change which occurs in relation to manufacture of the pharmaceutical ingredient involves a risk of affecting both (1) quality of a product and (2) content of license approved by a public institution. In Application Example 1, the following steps N11 through N16 are carried out.
Step N11: The manufacturer causes the information processing device 10_1 to carry out the steps S501 through S503 of FIG. 11 in order to notify users, to which the pharmaceutical ingredient has been sold, of information indicative of the change that has occurred in relation to manufacture of the pharmaceutical ingredient.
Step N12: The user determines that the change involves a risk of affecting both (1) quality of a product and (2) content of license approved by a public institution.
Step N13: The user applies, to the public institution, for a change of the content of license which has been approved.
Step N14: The user causes the information processing device 10_4 to carry out the steps S507 and S508 of FIG. 11 in order to instruct the manufacturer to “deliver the pharmaceutical ingredient manufactured without applying the change until the application for change is approved” as information indicative of a response.
Step N15: The user, upon receipt of approval for the application for change from the public institution, causes the information processing device 10_4 to carry out the steps S507 and S508 of FIG. 11 again in order to notify the manufacturer of the information indicative of the response which is “agreement with the change”.
Step N16: The user and the manufacturer modify the content of quality contract, as necessary.

### APPLICATION EXAMPLE 2

In Application Example 2, a case will be described in which a change which occurs in relation to manufacture of the pharmaceutical ingredient involves a risk of affecting (1) quality of a product but does not involve a risk of affecting (2) content of license approved by a public institution. In Application Example 2, the following steps N21 through N25 are carried out.
Step N21: The manufacturer causes the information processing device 10_1 to carry out the steps S501 through S503 of FIG. 11 in order to notify users, to which the pharmaceutical ingredient has been sold, of information indicative of the change that has occurred in relation to manufacture of the pharmaceutical ingredient.
Step N22: The user determines that the change involves a risk of affecting (1) quality of a product but does not involve a risk of affecting (2) content of license approved by a public institution.
Step N23: The user causes the information processing device 10_4 to carry out the steps S507 and S508 of FIG. 11 in order to instruct the manufacturer to “deliver the pharmaceutical ingredient manufactured without applying the change until an evaluation process with respect to the change ends” as information indicative of a response.
Step N24: The user, after the evaluation process has ended, causes the information processing device 10_4 to carry out the steps S507 and S508 of FIG. 11 in order to notify the manufacturer of the information indicative of the response which indicates that “the evaluation process has ended”.
Step N25: The user and the manufacturer modify the content of quality contract, as necessary.

### APPLICATION EXAMPLE 3

In Application Example 3, a case will be described in which a change which occurs in relation to manufacture of the pharmaceutical ingredient involves a risk of affecting neither (1) quality of a product nor (2) content of license approved by a public institution. In Application Example 3, the following steps N31 through N33 are carried out.
Step N31: The manufacturer causes the information processing device 10_1 to carry out the steps S501 through S503 of FIG. 11 in order to notify users, to which the pharmaceutical ingredient has been sold, of information indicative of the change that has occurred in relation to manufacture of the pharmaceutical ingredient.
Step N32: The user determines that the change involves a risk of affecting neither (1) quality of a product nor (2) content of license approved by a public institution.
Step N33: The user causes the information processing device 10_4 to carry out the steps S507 and S508 of FIG. 11 in order to notify the manufacturer of the information indicative of the response which is “agreement with the change”.

<Effects of Present Embodiment>

As described above, the present embodiment allows the manufacturer to more surely notify users, to which the pharmaceutical ingredient has been sold, of information indicative of the change that has occurred in relation to manufacture of the pharmaceutical ingredient. In addition, the present embodiment can reduce operation costs related to communication between the manufacturer and the user necessitated due to such a change.

Moreover, in the present embodiment, the information indicative of transaction content of the pharmaceutical ingredient is recorded in the blockchain, and this makes it possible to record the information indicative of transaction content as information that is difficult to tamper and easy to trace. As a result, it is possible to improve reliability of various services using information which records transaction content of the pharmaceutical ingredient.

[Variation 1]

In the present embodiment, the example has been described in which the information indicative of transaction content of the pharmaceutical ingredient is registered in the blockchain system. The present embodiment is not limited to this, and information indicative of transaction content may be registered in a database system other than the blockchain system. As such a database system, for example, it is possible to employ a database system that can store data corresponding to the transaction data D1 illustrated in FIG. 3. In this case, the information processing device 10_1 associated with the manufacturer may refer to the information indicative of transaction content recorded in the database system to extract a user to which the pharmaceutical ingredient, for which a change has occurred in relation to manufacture thereof, has been sold. As a result, the present embodiment brings about an effect similar to that described above even in the case where a database system other than the blockchain system is used.

Moreover, in the present embodiment, the example has been described in which the pharmaceutical ingredient is applied as the article in the present invention. The present embodiment is not limited thereto, and a drug may be applied as the article in the present invention. In this case also, the present embodiment brings about an effect similar to that described above.

In the present embodiment, the example has been described in which the pieces of transaction data respectively indicative of transaction content, notification information, and reliability information are registered in the blockchain system. The present embodiment is not limited to this, and transaction data indicative of other information related to a transaction of the pharmaceutical ingredient may be registered in the blockchain system. For example, stock information by a warehousing company, customs clearance information by a customs broker, and the like may be registered in the blockchain system.

In the present embodiment, each of the information processing devices 10_2 and 10_3 associated with the middlemen may further include a reliability outputting section 122. This allows the middlemen to view reliability information of the manufacturer or user, or reliability information of the pharmaceutical ingredient, as necessary.

In the present embodiment, each of the information processing devices 10 may output a transmission/reception history of information which has been transmitted/received for the corresponding pharmaceutical ingredient. For example, the information processing device 10 refers to the blockchain system 200 to search for transaction data including an ingredient ID of interest among pieces of transaction data of the type “notification information”, and outputs information, in which the retrieved pieces of transaction data are arranged in the order of the registration date and time, as the transmission/reception history. Thus, the user of each of the information processing devices 10 can ascertain the history of changes that have occurred in relation to manufacture of a pharmaceutical ingredient of interest and responses to those changes.

In the present embodiment, for each piece of transaction data, a transaction subject having authority to view information contained in that piece of transaction data may be set. For example, the transaction registering section 111 may encrypt information indicative of transaction content and include the information in the transaction data. In this case, the information for decrypting the encrypted information is given to a transaction subject having the authority to view the information. A method of setting, for each piece of transaction data, a transaction subject having authority to view is not limited to the above described method.

In the present embodiment, the example has been described in which the information processing system 1 includes one blockchain system 200. The present embodiment is not limited to this, and the information processing system 1 may include a plurality of blockchain systems 200. In this case, the transaction registering section 111 of the information processing device 1 may register transaction data indicative of transaction content in a blockchain system 200 corresponding to a transaction route so as to associate the transaction route with the chain of blocks. Moreover, the change registering section 134 and the response registering section 144 may register transaction data indicative of content of a change or content of a response in a blockchain system 200, which contains related notification information, so as to associate the relevance of the notification information with the chain of blocks. Moreover, the reliability registering section 121 may register transaction data indicative of reliability information in a blockchain system 200, which contains related reliability information, so as to associate the relevance of the reliability information with the chain of blocks. In all the cases, if there is no blockchain system 200 in which certain transaction data is to be registered, the information processing system 1 adds a new blockchain system 200 and registers the certain transaction data in that new blockchain system 200.

In the present embodiment, the example has been described in which information indicative of a change is information indicative of a change that has occurred in relation to manufacture of the pharmaceutical ingredient. The present embodiment is not limited to this, and the information indicative of a change may be information indicative of a change that has occurred in relation to evaluation of the pharmaceutical ingredient.

[Variation 2]

In the foregoing embodiment of the present invention, as an example of the article in the present invention, a cosmetic ingredient may be applied instead of the pharmaceutical ingredient. The information processing system 1 in accordance with this Variation is a system for transmitting information, which indicates a change that has occurred in relation to manufacture or evaluation of a cosmetic ingredient, to an information processing device associated with a user to which the cosmetic ingredient has been sold.

This Variation is similarly described by replacing the term “pharmaceutical” with “cosmetic” and replacing the phrase “change that has occurred in relation to manufacture” with “change that has occurred in relation to manufacture or evaluation” in the above embodiment and the drawings. In addition to the above replacement of terms and phrases, the following description is added to this Variation.

(Specific Examples of Change in Relation to Cosmetic Ingredient)

Specific examples of changes in relation to the cosmetic ingredient will be described first. The change in relation to the cosmetic ingredient is a change that occurs in relation to manufacture or evaluation of the cosmetic ingredient. Such a change includes the following specific examples, in addition to the foregoing specific examples of the change that occurs in relation to manufacture of the pharmaceutical ingredient. Here, specific examples relating to respective changes will be described by classifying them into either “change in relation to evaluation” or “change in relation to manufacture”.

(Specific Examples of Change in Relation to Evaluation)

### Change in Evaluation Test for Efficacy

A change may occur in an evaluation test for evaluating efficacy of the cosmetic ingredient. For example, the change in an evaluation test is changing a first evaluation test, which has been conducted to evaluate the efficacy of the cosmetic ingredient, to a second evaluation test. Moreover, for example, the change in an evaluation test is adding a second evaluation test to a first evaluation test. Moreover, for example, the change in an evaluation test is deleting any of a plurality of evaluation tests. An example of the change in an evaluation test includes, but is not limited to, an example in which an evaluation test by animal experiment is changed to an evaluation test by cell experiment.

### Change in Evaluation Test for Safety

A change may occur in a safety test for evaluating safety of the cosmetic ingredient. For example, the change in a safety test is changing a first safety test, which has been conducted to check the safety of the cosmetic ingredient, to a second safety test. Moreover, for example, the change in a safety test is adding a second safety test to a first safety test. Moreover, for example, the change in a safety test is deleting any of a plurality of safety tests. An example of the change in a safety test includes, but is not limited to, a specific example in which a safety test by animal experiment is changed to a safety test in which no animal experiment is conducted.

(Specific Examples of Change in Relation to Manufacture)

### Change of Impurities, By-Products, or Carryover Components

### Change in Official Certificate for Guarantee

A change may occur in an official certificate for guaranteeing the cosmetic ingredient. For example, the change in an official certificate for guarantee is changing a first official certificate, which guarantees the cosmetic ingredient, to a second official certificate. Moreover, for example, the change in an official certificate for guarantee is adding a second official certificate to a first official certificate. Moreover, for example, the change in an official certificate for guarantee is deleting any of a plurality of official certificates. Examples of the official certificate include, but are not limited to, the Japanese Standards of Quasi-drug Ingredients 2006, the standards listed in the appendix of the Japanese Standards of Quasi-drug Ingredients 2006, the Japanese Pharmacopoeia, the Japanese Standard of Food Additives, the Japanese Pharmaceutical Codex 2002, and the Ministerial ordinance stipulating tar pigments that can be used in pharmaceuticals.

### Change in Regulations on Chemical Substances in Various Countries

A change may occur in a regulation in any of various countries on a chemical substance related to the cosmetic ingredient. The change in a regulation on a chemical substance means, for example, revision in content of the regulation. Moreover, the change in a regulation means, for example, that a regulatory item is added to the regulation. Examples of such regulations include, but are not limited to, Chemical Abstracts Service (CAS) Registration Number, European Inventory of Existing Commercial Chemical Substances (EINECS) Number, European List of Notified Chemical Substances (ELINCS) Number, Registration, Evaluation, Authorization and Restriction of Chemicals (REACH), Toxic Substances Control Act (TSCA), the Law concerning the Examination and Regulation of Manufacture, etc. of Chemical Substances, the Industrial Safety and Health Law, Measures for Environmental Management of New Chemical Substances in China, Canadian Environmental Protection Act (CEPA), Australian Inventory of Chemical Substances (AICS), and the like.

### Change in Regulations on Cosmetic Products in Various Countries

A change may occur in a regulation in any of various countries on a cosmetic product that can contain the cosmetic ingredient. The change in a regulation on a cosmetic product means, for example, revision in content of the regulation. Moreover, the change in a regulation means, for example, that a regulatory item is added to the regulation. Examples of countries having such regulations include, but are not limited to, the EU, China, Japan, and US.
Change in standard document
Change of country of origin
Change of manufacturer or manufacturing location
Change of packaging form (net weight)
Change of indicated name or International Nomenclature of
Cosmetic Ingredient (INCI) Name
Change of manufacturer, customer, or quality assurance company

Organizations related to cosmetic ingredients are susceptible to consolidation due to acquisitions, and the like. Therefore, such changes of companies can easily occur.
Change of address, contact information, and the like of manufacturer, customer, or quality assurance company
Change in storage condition
Change in information relating to manufacturing period, supply period or quality assurance period
Change in certification information

For example, the change in certification information includes cases where the manufacturer itself revokes an obtained certification related to the cosmetic ingredient, the manufacturer does not renew the obtained certification, and the manufacturer obtains a new certification.

### Change in Patent Information

For example, a change in patent information may include expiration of a registered patent for the ingredient or a cosmetic use, etc. using the ingredient, invalidation of a registered patent, and publication/registration of a new patent. In some cases, a manufacturer of an ingredient may be, but is not limited to, an applicant for a patent indicated by patent information. Here, in cosmetics, there are cases where it is permitted to indicate a patent number or the like on a package, a package insert, or the like. If there is a change in patent information, it is also necessary to change the indicated patent information. Moreover, depending on content of a change in patent information, it is necessary to consider license grant.

(Specific Examples of Influence of Change in Relation to Cosmetic Ingredient)

Changes in relation to the cosmetic ingredient, as represented by the above specific examples, may affect (1) quality of a product, (2) certification content which has been certified by a certification organization, and (3) a part or whole of a product image on consumers. Moreover, the influence on some or all of (1) through (3) may further affect an effect and efficacy that can be selling points of the product and/or a method of advertisement. Thus, when the user has been notified of a change that has occurred in relation to manufacture or evaluation of the cosmetic ingredient, the user determines a risk that the change may affect each of (1) through (3) described above.

Here, the above (2) certification content which has been certified by a certification organization is certification content concerning the cosmetic ingredient or a cosmetic product containing the cosmetic ingredient. Examples of the certification content include, but are not limited to, certification content by quasi-drugs, Halal certification, ECOCERT certification, COSMOS certification, and the like. A certification organization in relation to the pharmaceutical ingredient is a public institution. However, a certification organization in relation to the cosmetic ingredient is not necessarily a public institution. In other words, a certification organization in relation to the cosmetic ingredient may be a public institution or a private institution.

The above (3) product image on consumers is a product image based on a raw material, manufacturing method, or evaluation method of a cosmetic ingredient used in the product. Examples of the product image include, but are not limited to, expressions such as “sustainable”, “animal-free”, “additive-free” and “fair trade” (concept representing transaction fairness). The product image affects consumer's willingness to purchase.

### Application Example 1 for Cosmetic Ingredient

In Application Example 1, a case will be described in which a change which occurs in relation to manufacture of the cosmetic ingredient involves a risk of affecting both (1) quality of a product and (2) certification content which has been certified by a certification organization but does not involve a risk of affecting (3) product image on consumers (willingness to purchase). Steps carried out in Application Example 1 are similarly described by replacing the term “pharmaceutical” with “cosmetic” in the above described steps N11 through N16 in relation to the pharmaceutical ingredient.

### Application Example 2 for Cosmetic Ingredient

In Application Example 2, a case will be described in which a change which occurs in relation to manufacture of the cosmetic ingredient involves a risk of affecting (1) quality of a product and (3) product image on consumers but does not involve a risk of affecting (2) certification content which has been certified by a certification organization. Steps carried out in Application Example 2 are similarly described by replacing the term “pharmaceutical” with “cosmetic” in the above described steps N21 through N25 in relation to the pharmaceutical ingredient.

### Application Example 3 for Cosmetic Ingredient)

In Application Example 3, a case will be described in which a change which occurs in relation to manufacture of the cosmetic ingredient does not involves a risk of affecting any of (1) quality of a product, (2) certification content which has been certified by a certification organization, and (3) product image on consumers. Steps carried out in Application Example 3 are similarly described by replacing the term “pharmaceutical” with “cosmetic” in the above described steps N31 through N33 in relation to the pharmaceutical ingredient.

<Effect of Variation 2>

As described above, Variation 2 allows the manufacturer to more surely notify users, to which the cosmetic ingredient has been sold, of information indicative of the change that has occurred in relation to manufacture or evaluation of the cosmetic ingredient. In addition, the present embodiment can reduce operation costs related to communication between the manufacturer and the user necessitated due to such a change.

As a result, the user can change the effect and efficacy that can be the selling points of the cosmetic product and the advertising method in consideration of the influence of such a change. Therefore, it is possible to promote the consumer's willingness to purchase.

Moreover, in the present embodiment, the information indicative of transaction content of the cosmetic ingredient is recorded in the blockchain, and this makes it possible to record the information indicative of transaction content as information that is difficult to tamper and easy to trace. As a result, it is possible to improve reliability of various services using information which records transaction content of the cosmetic ingredient.

[Other Variation]

The article in the present invention is not limited to the pharmaceutical ingredient and the cosmetic ingredient in the embodiment and Variation 1 of the present invention described above. For example, the article in the present invention may be a product (e.g. a pharmaceutical product, a cosmetic product, or a detergent), an ingredient of the product, a food or drink, an ingredient of the food or drink, a pesticide, an ingredient of the pesticide, an industrial product, or an ingredient of the industrial product. The article in the present invention is not limited to these article examples, and the present invention is applicable to other articles with transaction problems that are to be solved by the present invention.

In addition, the cosmetic ingredient in the present invention is an ingredient used in manufacture of a cosmetic product. For example, the cosmetic ingredient may be an additive (all components) or an active ingredient or the like to be blended in a cosmetic product. Moreover, examples of such a cosmetic product include, but are not limited to, a skin care cosmetic product, a hair cosmetic product, a makeup cosmetic product, a washing agent, a bathing agent, and a fragrance. Further, the cosmetic product may be a quasi-drug.

[Example of Configuration Achieved by Software]

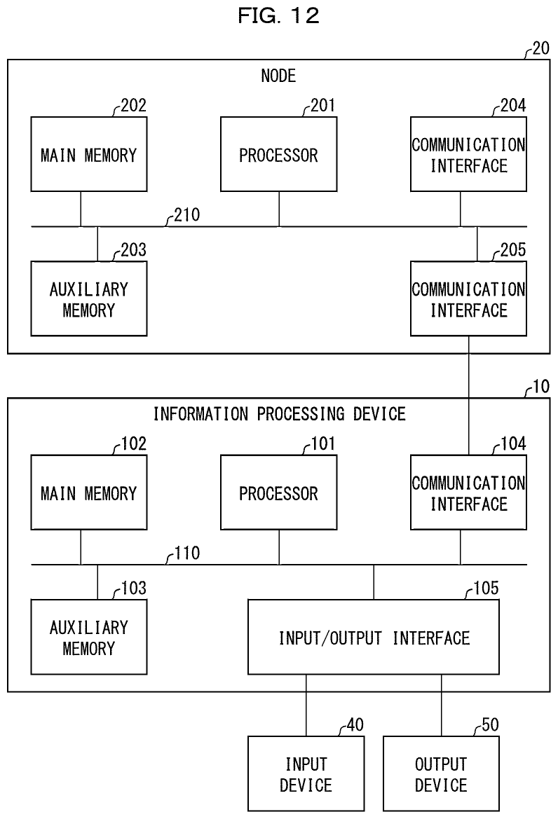

Functional blocks of the information processing device (particularly, the transaction process section 11, the reliability process section 12, the change process section 13, and the response process section 14) and functional blocks of the node 20 (the blockchain storage section 21, the transaction receiving section 22, the sharing section 23, the block adding section 24, and the transaction outputting section 25) each can be realized by a logic circuit (hardware) provided in an integrated circuit (IC chip) or the like or can be alternatively realized by software. In the latter case, the information processing device 10 and the node 20 each can be configured by, for example, a computer (electronic computer). FIG. 12 is a block diagram illustrating an example of a physical configuration of a computer which is used as the information processing device 10 and the node 20.

(Physical Configuration of Information Processing Device 10)

The information processing device 10 can be configured by a computer which includes a bus 110, a processor 101, a main memory 102, an auxiliary memory 103, a communication interface 104, and an input/output interface 105, as illustrated in FIG. 12. The processor 101, the main memory 102, the auxiliary memory 103, the communication interface 104, and the input/output interface 105 are interconnected with each other via the bus 110. To the input/output interface 105, the input device 40 and the output device 50 are connected.

The processor 101 can be, for example, a microprocessor, a digital signal processor, a microcontroller, or any combination of these processors.

The main memory 102 can be, for example, a semiconductor random access memory (RAM).

The auxiliary memory 103 can be, for example, a flash memory, a hard disk drive (HDD), a solid state drive (SSD), or any combination of these memories. In the auxiliary memory 103, a program for causing the processor 101 to execute the operations of the information processing device 10 described above is stored. The processor 101 causes the program stored in the auxiliary memory 103 to be loaded in the main memory 102 and executes instructions contained in the loaded program. In addition, in the auxiliary memory 103, various data to which the processor 101 refers so as to cause the computer to operate as the information processing device 10 are stored.

The communication interface 104 connects to the network 91.

The input/output interface 105 can be, for example, a universal serial bus (USB) interface, a near field communication interface such as an infrared interface and Bluetooth (registered trademark), or any combination of these interfaces.

The input device 40 can be, for example, a keyboard, a mouse, a touch-pad, a microphone, or any combination of these devices. The output device 50 can be, for example, a display, a printer, a speaker, or any combination of these devices.

(Physical Configuration of Node 20)

The node 20 can be configured by a computer which includes a bus 210, a processor 201, a main memory 202, an auxiliary memory 203, a communication interface 204, and a communication interface 205, as illustrated in FIG. 12. The processor 201, the main memory 202, the auxiliary memory 203, the communication interface 204, and the communication interface 205 are interconnected with each other via the bus 210.

The processor 201 can be, for example, a microprocessor, a digital signal processor, a microcontroller, or any combination of these processors.

The main memory 202 can be, for example, a semiconductor RAM.

The auxiliary memory 203 can be, for example, a flash memory, an HDD, an SSD, or any combination of these memories. In the auxiliary memory 203, a program for causing the computer to operate as the node 20 is stored. The processor 201 causes the program stored in the auxiliary memory 203 to be loaded in the main memory 202 and executes instructions contained in the loaded program. In addition, in the auxiliary memory 203, the above-described blockchain, and various data to which the processor 201 refers so as to cause the computer to operate as the node 20 are stored.

The communication interface 204 connects to the network 91. The communication interface 205 connects to the network 92.

Note that the above-described programs each may be made available to the computer by being stored in an external storage medium and read from the external storage medium, instead of being stored in the auxiliary memory 103 or the auxiliary memory 203. Examples of the external storage medium encompass a computer-readable “non-transitory tangible medium” such as a tape, a disk, a card, a semiconductor memory, and a programmable logic circuit. The programs each may be made available to the computer via any transmission medium (such as a communication network and a broadcast wave) which allows the program to be transmitted. Note that an aspect of the present invention can also be achieved in the form of a data signal in which the program is embodied via electronic transmission and which is embedded in a carrier wave.

Aspects of the present invention can also be expressed as follows:

The pharmaceutical ingredient in accordance with the foregoing embodiment is an example of a “pharmaceutical product” in the information processing system in accordance with the following aspect and includes an active pharmaceutical ingredient, an additive, and an ingredient/raw material of an active pharmaceutical ingredient.

The information processing system in accordance with an aspect of the present embodiment includes: information processing devices that are respectively associated with a plurality of transaction subjects relating to transactions of a pharmaceutical product; and a database in which information indicative of transaction content related to each of the plurality of transaction subjects is registered by an information processing device associated with that transaction subject, the plurality of transaction subjects including a manufacturer that manufactures the pharmaceutical product and a user that uses the pharmaceutical product, among the information processing devices, an information processing device associated with the manufacturer including a change obtaining section that obtains information indicative of a change which has occurred in relation to manufacture of the pharmaceutical product, a user extracting section that extracts, with reference to the database, a user to which the manufacturer has sold the pharmaceutical product, from among the plurality of transaction subjects, and a change transmitting section that transmits the information indicative of the change to an information processing device associated with the user which has been extracted by the user extracting section.

According to the configuration, it is possible to carry out communication between the transaction subjects for a change, which has occurred in relation to manufacture of the pharmaceutical product, more reliably while reducing a burden on a person in charge.

In the information processing system in accordance with the foregoing aspect, it is preferable that the database is constituted by a blockchain that is shared by a plurality of nodes and has a sequence of blocks containing transaction data, the plurality of nodes being configured to approve a block by using a predetermined consensus algorithm and the block being added to the blockchain.

According to the configuration, the information indicative of transaction content is recorded in the form that is difficult to tamper and is easy to trace, and this makes it possible to more reliably extract the user to which the manufacturer has sold the pharmaceutical product.

In the information processing system in accordance with the foregoing aspect, it is preferable that, among the information processing devices, the information processing device associated with the user includes: a change receiving section that receives the information indicative of the change from the information processing device associated with the manufacturer; a response obtaining section that obtains information indicative of a response to the change; and a response transmitting section that transmits the information indicative of the response to the information processing device which has transmitted the information indicative of the change.

According to the configuration, the user that has been informed of the change, which has occurred in relation to manufacture of the pharmaceutical product, can more reliably respond to the manufacturer while reducing a burden on a person in charge.

In the information processing system in accordance with the foregoing aspect, it is preferable that: the information processing device associated with the manufacturer further includes a change registering section that registers the information indicative of the change, which has been transmitted by the change transmitting section, in the database while associating the information indicative of the change with the pharmaceutical product; and the information processing device associated with the user further includes a response registering section that registers the information indicative of the response, which has been transmitted by the response transmitting section, in the database while associating the information indicative of the response with the pharmaceutical product.

According to the configuration, the user can ascertain the history of changes that have occurred in relation to manufacture of the pharmaceutical product and responses to those changes by viewing information recorded in the database.

In the information processing system in accordance with the foregoing aspect, it is preferable that each of the information processing devices further includes: a reliability registering section that registers, in the database, information indicative of reliability of the pharmaceutical product or reliability of any of the plurality of transaction subjects; and a reliability outputting section that outputs, with reference to the database, the information indicative of reliability which has been registered by another one of the information processing devices.

According to the configuration, the user can view information indicative of reliability, which has been registered by an information processing device associated with another transaction subject, without inquiring of that another transaction subject. As a result, an operation cost for inquiring information indicative of reliability is reduced.

In the information processing system in accordance with the foregoing aspect, it is preferable that the plurality of transaction subjects further includes a middleman that is included in a transaction route of the pharmaceutical product, and each of the information processing devices further includes: a transaction registering section that registers the information indicative of transaction content in the database when the transaction has been carried out by a transaction subject associated with that information processing device; and a transaction progress outputting section that outputs, with reference to the database, information indicative of a transaction progress of the pharmaceutical product at a certain point in time.

According to the configuration, the user can ascertain the progress of transactions in relation to the pharmaceutical product.

An information processing system in accordance with an aspect of the present embodiment includes information processing devices that are respectively associated with a plurality of transaction subjects relating to transactions of a pharmaceutical ingredient, each of the information processing devices including a transaction registering section that registers, in a database, transaction data indicative of transaction content of the pharmaceutical ingredient, the database being constituted by a blockchain that is shared by a plurality of nodes and has a sequence of blocks containing transaction data, and the plurality of nodes being configured to approve a block by using a predetermined consensus algorithm and the block being added to the blockchain.

According to the configuration, the information indicative of transaction content of the pharmaceutical ingredient can be recorded in the form that is difficult to tamper and is easy to trace.

The information processing device in accordance with an aspect of the present embodiment is an information processing device associated with a manufacturer that manufactures a pharmaceutical product among a plurality of transaction subjects relating to transactions of the pharmaceutical product, the information processing device including: a change obtaining section that obtains information indicative of a change which has occurred in relation to manufacture of the pharmaceutical product with use of a database in which information indicative of transaction content related to each of the plurality of transaction subjects is registered by an information processing device associated with that transaction subject; a user extracting section that extracts, with reference to the database, a user to which the manufacturer has sold the pharmaceutical product, from among the plurality of transaction subjects; and a change transmitting section that transmits the information indicative of the change to an information processing device associated with the user which has been extracted by the user extracting section.

According to the configuration, it is possible to carry out communication between the transaction subjects for a change, which has occurred in relation to manufacture of the pharmaceutical product, more reliably while reducing a burden on a person in charge.

The information processing method in accordance with an aspect of the present embodiment is an information processing method carried out by an information processing device associated with a manufacturer that manufactures a pharmaceutical product among a plurality of transaction subjects relating to transactions of the pharmaceutical product, the method including the steps of: obtaining information indicative of a change which has occurred in relation to manufacture of the pharmaceutical product with use of a database in which information indicative of transaction content related to each of the plurality of transaction subjects is registered by an information processing device associated with that transaction subject; extracting, with reference to the database, a user to which the manufacturer has sold the pharmaceutical product, from among the plurality of transaction subjects; and transmitting the information indicative of the change to an information processing device associated with the user which has been extracted in the user extracting step.

According to the configuration, it is possible to bring about effects similar to those of the information processing device.

Furthermore, aspects of the present invention can also be expressed as follows:

The information processing system in accordance with another aspect includes: information processing devices that are respectively associated with a plurality of transaction subjects relating to transactions of an article; and a database in which information indicative of transaction content related to each of the plurality of transaction subjects is registered by an information processing device associated with that transaction subject, the plurality of transaction subjects including a manufacturer that manufactures the article and a user that uses the article, among the information processing devices, an information processing device associated with the manufacturer including a change obtaining section that obtains information indicative of a change which has occurred in relation to manufacture or evaluation of the article, a user extracting section that extracts, with reference to the database, a user to which the manufacturer has sold the article, from among the plurality of transaction subjects, and a change transmitting section that transmits the information indicative of the change to an information processing device associated with the user which has been extracted by the user extracting section.

According to the configuration, it is possible to carry out communication between the transaction subjects for a change, which has occurred in relation to manufacture or evaluation of the article, more reliably while reducing a burden on a person in charge.

In the information system in accordance with the foregoing another aspect, it is preferable that the article is a pharmaceutical ingredient.

According to the configuration, it is possible to carry out communication between the transaction subjects for a change, which has occurred in relation to manufacture or evaluation of the pharmaceutical ingredient, more reliably while reducing a burden on a person in charge.

In the information system in accordance with the foregoing another aspect, it is preferable that the article is a cosmetic ingredient.

According to the configuration, it is possible to carry out communication between the transaction subjects for a change, which has occurred in relation to manufacture or evaluation of the cosmetic ingredient, more reliably while reducing a burden on a person in charge.

In the information system in accordance with the foregoing another aspect, it is preferable that the information indicative of the change is information that has a possibility to influence certification content which has been certified by a certification organization.

Here, in relation to manufacture or evaluation of an article, a certification organization may grant certification. In a case where a change has occurred in such certification content, the manufacturer that manufactures the article may have to inform the user of the change, and thus communication between the transaction subjects is needed. According to the configuration, in a case where a change that influences the certification content which has been certified by a certification organization has occurred, it is possible to carry out communication between the transaction subjects for the change more reliably while reducing a burden on a person in charge.

In the information system in accordance with the foregoing another aspect, it is preferable that the database is constituted by a blockchain that is shared by a plurality of nodes and has a sequence of blocks containing transaction data, the plurality of nodes being configured to approve a block by using a predetermined consensus algorithm and the block being added to the blockchain.

According to the configuration, the information indicative of transaction content of the article is recorded in the form that is difficult to tamper and is easy to trace, and this makes it possible to more reliably extract the user to which the manufacturer has sold the article.

In the information system in accordance with the foregoing another aspect, it is preferable that, among the information processing devices, the information processing device associated with the user includes: a change receiving section that receives the information indicative of the change from the information processing device associated with the manufacturer; a response obtaining section that obtains information indicative of a response to the change; and a response transmitting section that transmits the information indicative of the response to the information processing device which has transmitted the information indicative of the change.

According to the configuration, the user that has been informed of the change, which has occurred in relation to manufacture or evaluation of the article, can more reliably respond to the manufacturer while reducing a burden on a person in charge.

In the information system in accordance with the foregoing another aspect, it is preferable that the information indicative of the response to the change includes information indicative of agreement with the change or a request for suspending the change.

Here, the manufacturer may need to obtain user's agreement with such a change in order to carry out manufacture while applying the change. In this case, the manufacturer needs to suspend the change until agreement is obtained, and to carry out manufacture without applying the change. According to the above configuration, the user can more reliably agree with the change or request suspension of the change, while reducing a burden on a person in charge.

In the information system in accordance with the foregoing another aspect, it is preferable that: the information processing device associated with the manufacturer further includes a change registering section that registers the information indicative of the change, which has been transmitted by the change transmitting section, in the database while associating the information indicative of the change with the article; and the information processing device associated with the user further includes a response registering section that registers the information indicative of the response, which has been transmitted by the response transmitting section, in the database while associating the information indicative of the response with the article.

According to the configuration, the user can ascertain the history of changes that have occurred in relation to manufacture or evaluation of the article and responses to those changes by viewing information recorded in the database.

In the information system in accordance with the foregoing another aspect, it is preferable that each of the information processing devices further includes: a reliability registering section that registers, in the database, information indicative of reliability of the article or reliability of any of the plurality of transaction subjects; and a reliability outputting section that outputs, with reference to the database, the information indicative of reliability which has been registered by another one of the information processing devices.

According to the configuration, the user can view information indicative of reliability, which has been registered by an information processing device associated with another transaction subject, without inquiring of that another transaction subject. As a result, an operation cost for inquiring information indicative of reliability is reduced.

In the information system in accordance with the foregoing another aspect, it is preferable that the plurality of transaction subjects further includes a middleman that is included in a transaction route of the article, and each of the information processing devices further includes: a transaction registering section that registers the information indicative of transaction content in the database when the transaction has been carried out by a transaction subject associated with that information processing device; and a transaction progress outputting section that outputs, with reference to the database, information indicative of a transaction progress of the article at a certain point in time.

According to the configuration, the user can ascertain the progress of transactions in relation to the article.

The information system in accordance with another aspect is an information processing system, including information processing devices that are respectively associated with a plurality of transaction subjects relating to transactions of a cosmetic ingredient, each of the information processing devices including a transaction registering section that registers, in a database, transaction data indicative of transaction content of the cosmetic ingredient, the database being constituted by a blockchain that is shared by a plurality of nodes and has a sequence of blocks containing transaction data, and the plurality of nodes being configured to approve a block by using a predetermined consensus algorithm and the block being added to the blockchain.

According to the configuration, the information indicative of transaction content of the cosmetic ingredient can be recorded in the form that is difficult to tamper and is easy to trace.

The information processing device in accordance with another aspect is an information processing device associated with a manufacturer that manufactures a cosmetic ingredient among a plurality of transaction subjects relating to transactions of the cosmetic ingredient, the information processing device including: a change obtaining section that obtains information indicative of a change which has occurred in relation to manufacture or evaluation of the cosmetic ingredient with use of a database in which information indicative of transaction content related to each of the plurality of transaction subjects is registered by an information processing device associated with that transaction subject; a user extracting section that extracts, with reference to the database, a user to which the manufacturer has sold the cosmetic ingredient, from among the plurality of transaction subjects; and a change transmitting section that transmits the information indicative of the change to an information processing device associated with the user which has been extracted by the user extracting section.

According to the configuration, it is possible to carry out communication between the transaction subjects for a change, which has occurred in relation to manufacture or evaluation of the cosmetic ingredient, more reliably while reducing a burden on a person in charge.

The information processing method in accordance with another aspect is an information processing method carried out by an information processing device associated with a manufacturer that manufactures a cosmetic ingredient among a plurality of transaction subjects relating to transactions of the cosmetic ingredient, the method including the steps of: obtaining information indicative of a change which has occurred in relation to manufacture or evaluation of the cosmetic ingredient with use of a database in which information indicative of transaction content related to each of the plurality of transaction subjects is registered by an information processing device associated with that transaction subject; extracting, with reference to the database, a user to which the manufacturer has sold the cosmetic ingredient, from among the plurality of transaction subjects; and transmitting the information indicative of the change to an information processing device associated with the user which has been extracted in the user extracting step.

According to the configuration, it is possible to bring about effects similar to those of the information processing device.

The present invention is not limited to the embodiments, but can be altered variously by a skilled person in the art within the scope of the claims.

### REFERENCE SIGNS LIST

1: Information processing system

10: Information processing device

11: Transaction process section

12: Reliability process section

13: Change process section

14: Response process section

20: Node

21: Blockchain storage section

22: Transaction receiving section

23: Sharing section

24: Block adding section

25: Transaction outputting section

40: Input device

50: Output device

91, 92: Network

101, 201: Processor

102, 202: Main memory

103, 203: Auxiliary memory

104, 204, 205: Communication interface

105: Input/output interface

110, 210: Bus

111: Transaction registering section

112: Transaction progress outputting section

121: Reliability registering section

122: Reliability outputting section

131: Change obtaining section

132: User extracting section

133: Change transmitting section

134: Change registering section

141: Change receiving section

142: Response obtaining section

143: Response transmitting section

144: Response registering section

200: Blockchain system

1. An information processing system, comprising:
information processing devices that are respectively associated with a plurality of transaction subjects relating to transactions of an article; and
a database in which information indicative of transaction content related to each of the plurality of transaction subjects is registered by an information processing device associated with that transaction subject,
the plurality of transaction subjects including a manufacturer that manufactures the article and a user that uses the article,
among the information processing devices, an information processing device associated with the manufacturer including
a change obtaining section that obtains information indicative of a change which has occurred in relation to manufacture or evaluation of the article,
a user extracting section that extracts, with reference to the database, a user to which the manufacturer has sold the article, from among the plurality of transaction subjects, and
a change transmitting section that transmits the information indicative of the change to an information processing device associated with the user which has been extracted by the user extracting section.

2. The information processing system as set forth in claim 1, wherein the article is a pharmaceutical ingredient.

3. The information processing system as set forth in claim 1, wherein the article is a cosmetic ingredient.

4. The information processing system as set forth in claim 1, wherein the information indicative of the change is information that has a possibility to influence certification content which has been certified by a certification organization.

5. The information processing system as set forth in claim 1, wherein the database is constituted by a blockchain that is shared by a plurality of nodes and has a sequence of blocks containing transaction data, the plurality of nodes being configured to approve a block by using a predetermined consensus algorithm and the block being added to the blockchain.

6. The information processing system as set forth in claim 1, wherein, among the information processing devices, the information processing device associated with the user includes:
a change receiving section that receives the information indicative of the change from the information processing device associated with the manufacturer;
a response obtaining section that obtains information indicative of a response to the change; and
a response transmitting section that transmits the information indicative of the response to the information processing device which has transmitted the information indicative of the change.

7. The information processing system as set forth in claim 6, wherein the information indicative of the response to the change includes information indicative of agreement with the change or a request for suspending the change.

8. The information processing system as set forth in claim 6, wherein:
the information processing device associated with the manufacturer further includes a change registering section that registers the information indicative of the change, which has been transmitted by the change transmitting section, in the database while associating the information indicative of the change with the article; and
the information processing device associated with the user further includes a response registering section that registers the information indicative of the response, which has been transmitted by the response transmitting section, in the database while associating the information indicative of the response with the article.

9. The information processing system as set forth in claim 1, wherein each of the information processing devices further includes:
a reliability registering section that registers, in the database, information indicative of reliability of the article or reliability of any of the plurality of transaction subjects; and
a reliability outputting section that outputs, with reference to the database, the information indicative of reliability which has been registered by another one of the information processing devices.

10. The information processing system as set forth in claim 1, wherein the plurality of transaction subjects further includes a middleman that is included in a transaction route of the article, and
each of the information processing devices further includes:
a transaction registering section that registers the information indicative of transaction content in the database when the transaction has been carried out by a transaction subject associated with that information processing device; and
a transaction progress outputting section that outputs, with reference to the database, information indicative of a transaction progress of the article at a certain point in time.

11. An information processing system, comprising information processing devices that are respectively associated with a plurality of transaction subjects relating to transactions of a cosmetic ingredient,
each of the information processing devices including
a transaction registering section that registers, in a database, transaction data indicative of transaction content of the cosmetic ingredient, the database being constituted by a blockchain that is shared by a plurality of nodes and has a sequence of blocks containing transaction data, and the plurality of nodes being configured to approve a block by using a predetermined consensus algorithm and the block being added to the blockchain.

12. (canceled)

13. (canceled)
